(19) United States
(12) Patent Application Publication
(10) Pub. No.: US 2026/0170339 A1
(43) Pub. Date: Jun. 18, 2026

(54) METHOD AND APPARATUS WITH DATA PROCESSING

(71) Applicants: Samsung Electronics Co., Ltd., Suwon-si (KR); POSTECH RESEARCH AND BUSINESS DEVELOPMENT FOUNDATION, Pohang-si (KR)

(72) Inventors: Seungwoo HONG, Pohang-si (KR); Dongyun KAM, Pohang-si (KR); Youngjoo LEE, Pohang-si (KR)

(73) Assignees: Samsung Electronics Co., Ltd., Suwon-si (KR); POSTECH RESEARCH AND BUSINESS DEVELOPMENT FOUNDATION, Pohang-si (KR)

(21) Appl. No.: 19/421,982

(22) Filed: Dec. 16, 2025

(30) Foreign Application Priority Data
Dec. 17, 2024 (KR) 10-2024-0188799

(51) Int. Cl. G06N 3/082

(52) U.S. Cl. CPC G06N 3/082

(57) ABSTRACT

A processor-implemented method including combining, in a current round of a current operation for a plurality of layers allocated to a core input data stored in a local memory of the core with first-direction overlap data generated in a previous round, in response to completion of the current operation on the plurality of layers allocated to the core, storing, in a global memory, feature map data generated as an operation result, storing, in the local memory or the global memory, first-direction overlap data and an output feature map generated as an operation result of a corresponding layer, for each of the plurality of layers, and performing additional operations on consecutive layers by using the output feature map as input data of a next layer of the corresponding layer.

### CROSS-REFERENCE TO RELATED APPLICATIONS

This application claims the benefit under 35 USC § 119(a) of Korean Patent Application No. 10-2024-0188799, filed on Dec. 17, 2024, in the Korean Intellectual Property Office, the entire disclosure of which is incorporated herein by reference for all purposes.

### BACKGROUND

### 1. Field

The following description relates to a method and apparatus with data processing, and more particularly, to a multi-layer fusion method and a deep learning accelerator structure.

### 2. Description of Related Art

Due to the development of artificial intelligence technology in various application fields today, deep learning-based data processing techniques are becoming increasingly important. In particular, data analysis and processing methods utilizing neural networks may play a key role in various fields such as image recognition, voice processing, and natural language processing. These technologies may operate by receiving data as an input, gradually processing the data through a neural network composed of multiple layers, and generating results that meet a determined purpose.

A traditional data processing method may have a structure in which a result of performing an operation for each layer is stored in memory and reloaded to be used as an operation input for a next layer. This method may have an advantage of being relatively simple to implement and scalable but may require high memory bandwidth during the storage and loading of intermediate data, which may cause processing speed of the system to decrease and energy consumption to increase.

To solve this, typical technologies propose using a layer fusion technique that performs operations by merging multiple consecutive layers. The layer fusion technique may reduce memory bandwidth usage and improve operational efficiency by combining multiple layers into a single processing process without storing intermediate data. However, even in this typical technique, the processing of overlap data between layers and optimizing memory usage may still remain important tasks.

Thus, in order to reduce memory usage and improve operational efficiency in the data processing process of a neural network, a more improved data processing method and device is desired.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a processor-implemented method including combining, in a current round of a current operation for a plurality of layers allocated to a core input data stored in a local memory of the core with first-direction overlap data generated in a previous round, in response to completion of the current operation on the plurality of layers allocated to the core, storing, in a global memory, feature map data generated as an operation result, storing, in the local memory or the global memory, first-direction overlap data and an output feature map generated as an operation result of a corresponding layer, for each of the plurality of layers, and performing additional operations on consecutive layers by using the output feature map as input data of a next layer of the corresponding layer.

The method may include loading input data from the global memory to the local memory of the core, the input data stored in the local memory of the core may include one or more of the input data loaded from the global memory or output data of a previous layer of the corresponding layer, stored in the local memory.
the first-direction overlap data may be generated in the previous round as an operation result of a layer allocated to the core and the first-direction overlap data may be reused in the current round as operation input data of a same layer allocated to the core.

The first-direction overlap data may be set in a direction orthogonal to a direction of progress of rounds.

The feature map data stored in the global memory may be configured to be provided as operation input data of a layer performed in another core.

The feature map data stored in the global memory may be configured for a skip connection operation among operations of another layer.

A plurality of cores may be configured to share the feature map data stored in the global memory and each core of the plurality of cores may be configured to independently perform an allocated layer operation of an allocated layer based on the feature map data.

The method may include storing, in the global memory or an external memory, second-direction overlap data generated in a current round and using the second-direction overlap data stored in the global memory or the external memory as operation input data of the core in one or more subsequent rounds according to a condition.

The core may include a plurality of subcores and the plurality of subcores may be configured to operate independently or collaboratively to process core data allocated to the subcores.

The performing of the additional operations on the consecutive layers may include performing fusion processing of the consecutive layers.

In a general aspect, here is provided an electronic apparatus including a plurality of cores, the apparatus including a global memory, a local memory included in each of the plurality of cores, a processor included in each of the plurality of cores, the processor being configured to execute instructions, a memory included in each of the plurality of cores, the memory storing the instructions, and an execution of the instructions respectively configures the processor to load input data from the global memory to the local memory to store the input data in the local memory, combine for a current round of a current operation, for a plurality of layers, the input data stored in the local memory with first-direction overlap data generated in a previous round, the first-direction overlap data being stored in one of the local memory or the global memory, and, in response to completion of the current operation on the plurality of layers, storing, in the global memory, feature map data generated as an operation result.

The input data stored in the local memory may include one or more of the input data loaded from the global memory or output data of a previous layer, among the plurality of layers, stored in the local memory.

The processor may be further configured to store, in the local memory, first-direction overlap data and an output feature map generated as an operation result of a corresponding layer, for each of the plurality of layers and perform additional operations on consecutive layers by using the output feature map as input data of a next layer.

The first-direction overlap data may be generated in the previous round by the processor and the first-direction overlap data may be reused in a current round as operation input data of a same layer among the plurality of layers.

The first-direction overlap data may be set in a direction orthogonal to a direction of progress of rounds.

The feature map data stored in the global memory may be configured to be provided as input data of an operation performed in another core among the plurality of cores.

The feature map data stored in the global memory may be configured to perform skip connection among other operations.

The plurality of cores may be configured to share the feature map data stored in the global memory and each core of the plurality of cores may be configured to independently perform an allocated operation based on the feature map data.

The processor may be further configured to store, in the global memory or an external memory, second-direction overlap data generated in a current round and use the second-direction overlap data stored in the global memory or the external memory as input data of the processor in a subsequent round according to a condition.

The processor may include a plurality of subcores and the plurality of subcores may be configured to operate independently or collaboratively to process core data allocated to the subcores.

Other features and aspects will be apparent from the following detailed description, the drawings, and the claims.

### BRIEF DESCRIPTION OF THE DRAWINGS

FIG. 1 illustrates an example of a difference between data processing methods illustrated by comparing a layer-by-layer operation method with a layer fusion method according to one or more embodiments.

FIG. 2 illustrates an example apparatus for performing an operation based on a multi-core structure according to one or more embodiments.

FIG. 3 illustrates an example method of performing a layer fusion operation in a round according to one or more embodiments.

FIG. 4 illustrates an example apparatus with a multi-core structure for performing operations according to one or more embodiments.

FIG. 5 illustrates an example apparatus with a multi-core structure for performing layer fusion operations according to one or more embodiments.

FIG. 6 illustrates an example process with second-direction overlap data according to one or more embodiments.

FIG. 7 illustrates an example method according to one or more embodiments.

FIG. 8 illustrates an example method according to one or more embodiments.

FIG. 9 illustrates an example electronic device according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

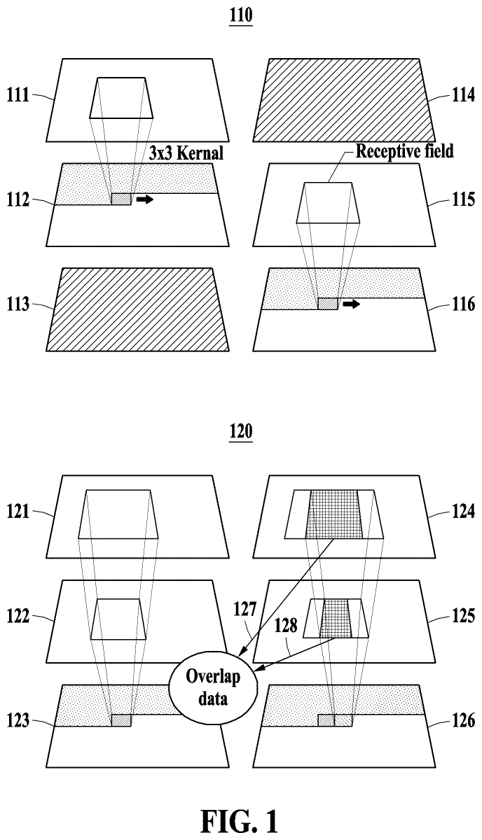

FIG. 1 illustrates an example of a difference between data processing methods illustrated by comparing a layer-by-layer operation method with a layer fusion method according to one or more embodiments.

Referring to FIG. 1, in a non-limiting example, a method 110 illustrates a layer-by-layer method, and input data 111 represents input data to be processed in a first layer (i.e., first layer 112). The input data may be, for example, image data with a size of 256×256, which may become a target of a kernel of the first layer. A kernel may perform an operation by referencing only a determined part of the input data. In addition, input data 114 is illustrated to demonstrate that the input data 114 may not be used for processing in subsequent layers (e.g., second layer 115). That is, input data 111 and input data 114 illustrate the same data and their respective applications to different layers.

In first layer 112, an operation illustrated which may be performed on the first layer by using a 3×3 sized kernel, where the kernel is used to perform an operation on a portion of the input data. In an example, a kernel may learn a local pattern of the input data or extract features of the input data. The kernel may sequentially process each field of the input data in a sliding window method, through which all fields of the input data may be traversed.

Output data 113 illustrates an example of the output from the first layer. In an example, output data from the second layer may not be used in a layer-by-layer operation (i.e., as illustrated in second layer 115) until the operation illustrated in data field 112 of the first layer is completed as shown in output data 113.

That is, with respect to input data 114, the processing shown in the second layer 115 may be performed after the output of the first layer is generated. Thus, an output value may be generated to populate the output data of the second layer 116 from the output data 113 of the first layer, while the input data 114 may not be used.

Thus, second layer 115 illustrates a process in which the kernel moves while processing each field of the input data for the second layer 115 obtained from output data 113. The kernel may move across the input data by a stride size and may perform operations by referencing a new receptive field at each move. For example, when the stride size is 1, the kernel may perform operations while moving one pixel at a time.

In output data 116, a process in which the kernel gradually fills in the output data is illustrated while processing all receptive fields of the input data. A result generated for each receptive field may be reflected at a specific location in the output data, and remaining parts of the output data may be filled in as the kernel operation progresses. The layer-by-layer method may process each layer independently and may require high memory bandwidth in a process of storing intermediate results in memory and reloading the intermediate results.

In an example, method 120 illustrates a layer fusion method. In the layer fusion method, a round may be an operational unit that performs operations on the same layers for a determined data set (e.g., a tile or a portion of the input data). In one round, a given set of tiles or input data may be processed, and operations may be performed on layers, from a first layer to a last layer. As the rounds progress, a size of the input data may gradually decrease by filtering and downsampling for each layer, and data connected between rounds and overlap data may change accordingly. For example, first, second, and third layers 121, 122, and 123 illustrate processes being performed within these layers in the first round while first, second, and third layers 124, 125, and 126 illustrate processes being performed within these layers in the second round.

In an example, in layer 121, a process for a determined tile of the first layer which is performed in the first round is illustrated. In this process, the input data may be processed through a kernel of the first layer, and output data may be generated as a result of the first layer. The output data may be used as an input for the second layer 122.

In an example, in the second layer 122, a process is illustrated for a determined tile of a second layer performed in the first round. Here, the second layer may perform an operation using the output data of the first layer as an input, and resulting data may be recorded as output data of the second layer. Next, third layer 123 illustrates a process for a determined tile for the third layer performed in the first round. Likewise, output data of a previous layer may be used as input data in this case (e.g., second layer 122).

In an example, first layer 124 illustrates process for a tile of a first layer performed in a second round. In this process, overlap data 127 generated in the first round may also be referenced in the second round. The second layer 125 illustrates a process for a tile of a second layer performed in the second round, which may refer to overlap data 128 generated in the previous round. The third layer 126 illustrates a process for a tile of a third layer performed in the second round.

In an example, overlap data may represent data that is used repeatedly across a plurality of rounds (e.g., two consecutive rounds) during a layer fusion operation process. The overlap data may be duplicate data that occurs at boundaries between tiles and may inevitably occur in tile-based operations. More specifically, the overlap data may occur in layers from a first layer to a last layer in a round, and since the last layer of a round may not generate final output data, overlap data may not occur in the last layer. For example, the overlap data 127 may represent data of the first layer that is referenced in both the first round and the second round, and overlap data 128 may represent data of the second layer that is referenced in both the first round and the second round. Overlap data may be a factor that reduces operational efficiency in the layer fusion method.

When using the layer fusion method, memory bandwidth requirements may be reduced by fusion-processing consecutive layer operations without having to store intermediate data in memory. However, processing overlap data remains an important challenge even in the layer fusion method.

As described in greater detail below, the method may apply a method of storing overlap data generated in a previous round based on a local memory or a global memory and reusing the overlap data. An operation may be performed by loading an input feature map and the overlap data stored in the local memory, and an operation result of a corresponding layer may be stored back in the local memory. The result saved in this way may be used as input data of a next layer, and fusion processing of consecutive layers may be performed through the layer fusion operation process. In an example, the process or operation being performed on consecutive layers may be fusion processing, where the output feature map of a preceding layer is used as input for a subsequent layer. In addition, other operations between the layers may be performed.

This approach may minimize duplicate operations and unnecessary memory accesses. Accordingly, an amount of operations and memory overhead may be significantly reduced and data processing efficiency may be improved. Reuse of the overlap data by using the local memory may be one of the important features of the present disclosure and may provide a method of effectively solving issues occurring in the existing methods.

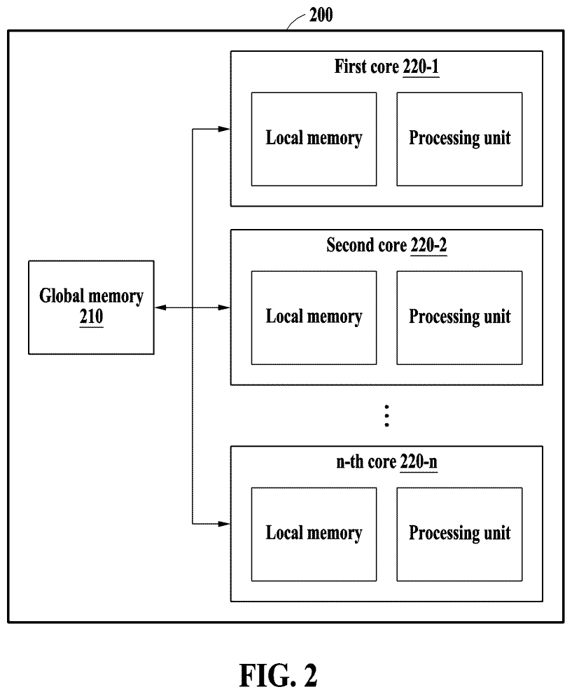

FIG. 2 illustrates an example apparatus for performing an operation based on a multi-core structure according to one or more embodiments. The description provided with reference to FIG. 1 may substantially equally apply to FIG. 2.

Referring to FIG. 2, in a non-limiting example, an electronic apparatus 200 may include a global memory 210 and a plurality of cores 220-1, 220-2, . . . , 220-n, and each core may include a local memory and a processing unit. However, other examples may be include more or less components than those as illustrated. For example, the electronic apparatus 200 and the plurality of cores 220-1, 220-2, . . . , 220-n may be implemented by more components than the shown components, and the electronic apparatus 200 and the plurality of cores 220-1, 220-2, . . . , 220-n may be implemented by fewer components.

The global memory 210 may be a storage device via which the plurality of cores 220-1, 220-2, . . . , 220-n may share data. The global memory 210 may store a large amount of data or share operation results between multiple cores by using memory technology such as dynamic random-access memory (DRAM). The global memory 210 may store input data, an operation result of each core, and final output data, thereby allowing collaboration between cores.

Each core may store input data in its local memory and perform various operations, including layer fusion operations, based on the input data. In this process, overlap data generated in a previous round may be loaded from the local memory and reused, and an operation result of each layer may directly be connected to an input of a next layer. This method may provide an effect of significantly reducing duplicate operations and memory accesses compared to typical methods that store intermediate data in a global memory and reloads the intermediate data.

A local memory included in each core may temporarily store data used by a corresponding core during performing an operation. The local memory may be implemented by technologies such as on-chip memory or static random-access memory (SRAM). The local memory may store overlap data, the input data, and intermediate operation results, and may allow efficient operations without loading or storing data from or in the global memory 210.

A layer fusion operation may sequentially process a plurality of layers within a same core, and each round may end when operations on a determined tile of the input data on layers, from a first layer to a last layer, are completed. Overlap data that occurs within a round may be stored in the local memory and reused for a next operation. After the round ends, an operation result of the last layer may be stored in the global memory 210, and this data may be fetched by other cores and used for additional operations when necessary.

In an example, for the plurality of cores 220-1, 220-2, . . . , 220-n, where each core may include a local memory and a processing unit. A core may process data independently or collaborate with other cores to perform tasks. For example, one core may process an operation of a specific layer or perform parallel operations by splitting the input data. For example, a first core 220-1 may sequentially process first, second, and third layers to generate final output data and store the final output data in the global memory 210. The data may be fetched by a second core 220-2 and used for operations in fourth, fifth, and sixth layers. This structure may allow data sharing between a plurality of cores via the global memory 210, and each core may independently perform layer fusion operations and may flexibly access data when collaboration is required.

Alternatively, in an example, the electronic apparatus 200 may divide the input data into a unit of tiles and distribute the tiles to each core, so that all cores may process a same layer in parallel. This approach may provide flexibility to the structure and may maximize benefits of parallel processing. In addition, the electronic apparatus 200 is not limited to layer fusion operations and may be utilized in various data processing methods. For example, the electronic apparatus 200 may also process a network structure such as skip connection.

The electronic apparatus 200 may efficiently manage the overlap data by utilizing the local memory and share data between cores through the global memory, thereby overcoming limitations of typical layer-by-layer methods and maximizing operational efficiency. Through this, the electronic apparatus 200 may reduce duplicate operations and memory overhead and may flexibly respond to various operational requirements.

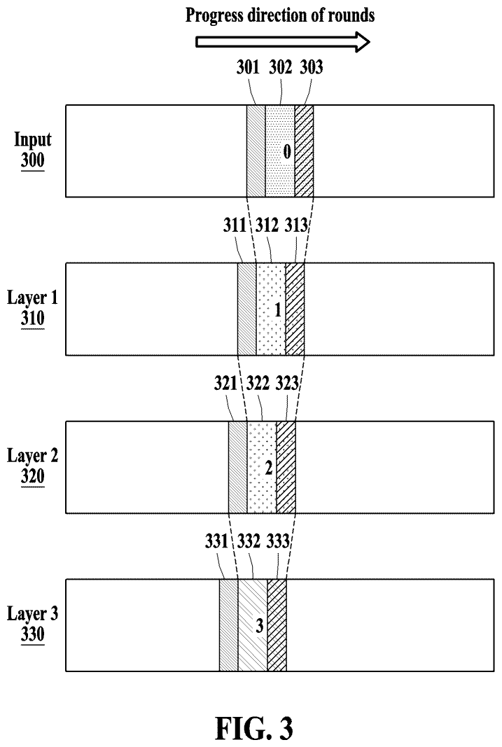

FIG. 3 illustrates an example method of performing a layer fusion operation in a round according to one or more embodiments. The description provided with reference to FIGS. 1 and 2 may also apply to FIG. 3.

Referring to FIG. 3, in a non-limiting example, a center area 302 of input data 300 may first be fetched from a global memory and combined with overlap data 301 generated in a previous round and stored in a local memory to perform an operation of a first layer 310. Through this process, output data 312 of the first layer 310 may be generated, and the data may be an area including overlap data 313 and the center area 302 of the input data 300. In addition, an edge portion 303 of the input data 300 may be stored in the local memory or the global memory as overlap data to be used for operations in a next round.

The output data 312 of the first layer 310 may be combined with overlap data 311 of the first layer 310 stored in a previous round and used as an operation input of a second layer 320. Through this process, output data 322 of the second layer 320 may be generated, and the data may also include a center area and overlap data 323. In addition, the edge portion 313 of the output data 312 of the first layer 310 may be stored in the local memory or the global memory as overlap data to be used in a next round. When the overlap data 311 is stored in the global memory, the overlap data 311 may be loaded from the global memory while the output data 312 is being generated from the center area 302 of the input data 300 that is in the local memory. Even in this case, bandwidth may be saved because the output data 312 of the first layer 310 and the output data 322 of the second layer 320 may not be transferred to the global memory.

In a similar manner, the output data 322 of the second layer 320 may be combined with overlap data 321 of the second layer 320 stored in a previous round and used as input data of a third layer 330. Output data 332 may be generated through an operation of the third layer 330, and the data may include a center area and overlap data 333. In addition, the edge portion 323 of the output data 322 of the second layer 320 may be stored in the local memory or the global memory as overlap data to be used in a next round. When a core finishes operations on all layers allocated to the core, the core may terminate a corresponding round and perform operations of a next round.

Since the rounds may progress in the second direction (e.g., a horizontal direction), there may be an area of data overlapping in the first direction (e.g., a vertical direction) between consecutive rounds. This first-direction overlap data may be used as an operation input in a next round. Through this structure, the method may significantly reduce operational and memory overhead occurring in the existing overlap data processing and may allow efficient operational and memory management.

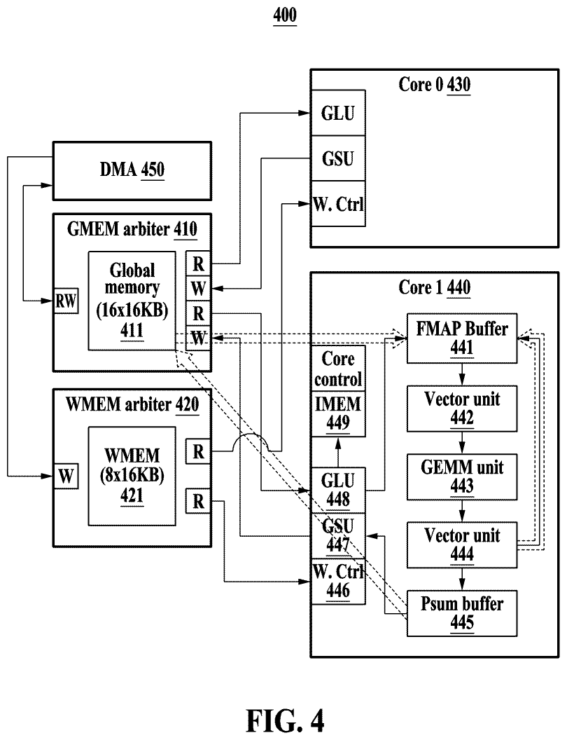

FIG. 4 illustrates an example apparatus with a multi-core structure for performing operations according to one or more embodiments. The description provided with reference to FIGS. 1 to 3 may also apply to FIG. 4.

Referring to FIG. 4, in a non-limiting example, an electronic apparatus 400 may be designed based on a global memory and a local memory structure and may thus support operations in a multi-core environment and efficient processing of data between layers. However, the electronic apparatus 400 illustrated in FIG. 4 represents one of the examples of the present disclosure, and the present disclosure is not necessarily limited to the configuration illustrated in FIG. 4. The present disclosure may implement components and structures of the operation apparatus in various ways, and the specific design and implementation method may be changed as needed. For example, a feature map buffer (FMAP Buffer), a global memory, a vector unit, and a general matrix multiplication (GEMM) unit may be replaced with other hardware or software elements capable of performing a same function, and the configuration and memory management method of the core may also be changed in various ways. Thus, the scope of the present disclosure is not limited by the accompanying drawings.

A global memory 411 may store input data and final output data and may provide data when data sharing between each core is required. Access to the global memory 411 may be controlled by a global memory arbiter (GMEM arbiter) 410, which may coordinate requests for each core to read or write data to prevent data conflicts and allow efficient memory accesses. In addition, weight data required for operation may be stored in a weight memory (WMEM) 421, and a weight memory arbiter (WMEM arbiter) 420 may control the WMEM 421 so that each core may receive necessary data in a timely manner.

An FMAP buffer 441, which may be a local memory, may store overlap data generated in a previous round and data loaded from a global memory in a current round. This structure may allow data required for operations to be quickly accessed from within each core. A vector unit 442 and a vector unit 444 may respectively perform pre-processing and post-processing of data, and a GEMM unit 443 may perform a core matrix multiplication operation in layer operations. An operation result may be temporarily stored in a Psum buffer 445 and may be stored in the global memory or used in a next operation as needed. An instruction memory (IMEM) 449 of a core may store instructions that control an operation of each core, and through this, processes required for the operation of each layer may be managed. A global load unit (GLU) 448 may load data from the global memory 411 and transfer the data to the local memory when necessary. The global storage unit (GSU) 447 may store operation result data in the global memory.

The process of performing operations on the input data 300 and the layers 310, 320, and 330 as illustrated above in FIG. 3 may be implemented based on the structure of FIG. 4 as follows. First, the center area 302 of the input data may be loaded from the global memory 411 and stored in the FMAP buffer 441. The overlap data 301 generated in the previous round may also be stored in the FMAP buffer 441. These data may be pre-processed through the vector unit 442 and subsequently transferred to the GEMM unit 443. In the GEMM unit 443, a matrix multiplication operation may be performed to generate the output data 312 of a first layer. Among the output data 312, the overlap data 313 used in a next round may be stored in the FMAP buffer 441.

The output data 312 of the first layer and the overlap data 311 of the first layer stored in the previous round may be used as operation input data of a second layer. Likewise, in an operation of the second layer, data may be processed through the vector unit 444 and the GEMM unit 443, and the output data 322 may be generated. Among the output data 322, the overlap data 323 used in a next round may be stored in the FMAP buffer 441. This process may be repeatedly performed for all layers, and when operations of each round is finally completed, the process may proceed to a next round. When operations on all layers allocated to a core in a corresponding round are completed, final output data of the corresponding round may be stored in the Psum buffer 445.

A skip connection operation may be effectively processed through an interaction of the global memory 411 and the FMAP buffer 441. The skip connection operation may occur when output data of a specific layer is reused in later layer operations, and this data dependency may be a significant issue in layer fusion operations.

In a process of processing a skip connection operation, output data of each layer may be stored in the global memory 441 after the operation is completed. For example, final output data of a specific layer may be written to the global memory 441, and the data may be used as input data of a skip connection operation in subsequent operations. The GMEM arbiter 410 may coordinate accesses without data conflicts when multiple cores request the data simultaneously. In this process, data for the skip connection operation may be transferred from the global memory to the local memory (e.g., the FMAP buffer 441) of each core so that the data may be used immediately for required operations. For example, the feature map data stored in the global memory may be configured to be used for the skip connection operation.

In addition, since the structure shown in FIG. 4 may be configured so that each core may operate independently in a multi-core environment, skip connection data generated in one core may be utilized in another core. For example, output data of a specific layer generated in a core 0 430 may be transferred to a core 1 440 through the global memory, and a skip connection operation may be performed based on this data. Through this, data dependency between operations may be efficiently resolved and performance of a multi-core system may be maximized.

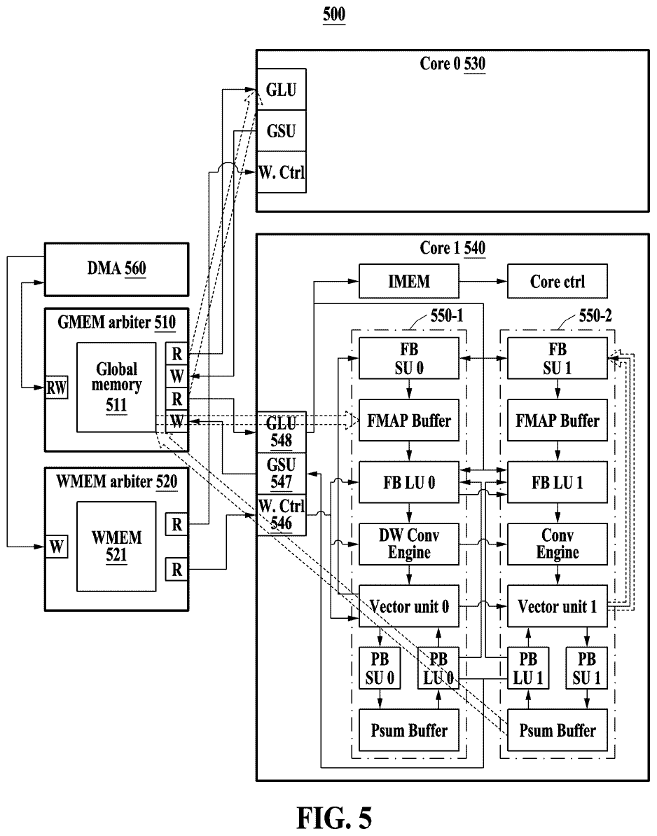

FIG. 5 illustrates an example apparatus with a multi-core structure for performing layer fusion operations according to one or more embodiments. Roles of each component and the overall content of the multi-core structure described with reference to FIG. 4 may equally apply to FIG. 5, and repeated descriptions may thus be omitted.

Referring to FIG. 5, in a non-limiting example, an electronic apparatus 500 may include a GMEM arbiter 510, a WMEM arbiter 520, a plurality of cores 530 and 540, and a DMA 560. The operation apparatus may load data from an external memory (e.g., DRAM) to a GMEM and a WMEM via the DMA 560. A core (e.g., the core 1 540) may include a plurality of subcores 550-1 and 550-2 to perform different operations. A subcore may operate independently and may be configured to have a structure optimized for a specific operation. For example, the core 1 540 may include the two subcores 550-1 and 550-2, and each of the two subcores 550-1 and 550-2 may process depthwise convolution operations and general convolution operations, respectively. Each of the subcores 550-1 and 550-2 may perform these operations using data allocated to the core (e.g., core data).

In an example, the first subcore 550-1 may perform depthwise convolution operations. The first subcore 550-1 may store input data in an FMAP Buffer, perform pre-processing in a vector unit (e.g., Vector Unit 0), and then perform an operation through a depthwise convolution engine (e.g., DW Conv Engine). An operation result may be stored in a Psum Buffer and may be used in consecutive operations or written to a global memory 511.

In an example, the second subcore 550-2 may perform general convolution operations. The second subcore 550-2 may store input data in the FMAP buffer SU1, process the data through a vector unit (e.g., Vector Unit 1) LU1, and subsequently perform an operation by using a general convolution engine (e.g., Conv Engine). The generated operation result may be stored in the Psum buffer SU1 and may be transferred to the global memory 511 when necessary.

The structure shown in FIG. 5 may provide high flexibility and expandability through the independent operation of the subcores. Each subcore may have components optimized for a specific operation and may thus increase operational efficiency and minimize data dependency and memory conflicts. In particular, the GMEM arbiter 510 and the WMEM arbiter 520 may coordinate when sub-cores access the memory simultaneously to prevent conflicts and may improve overall operational performance of a system.

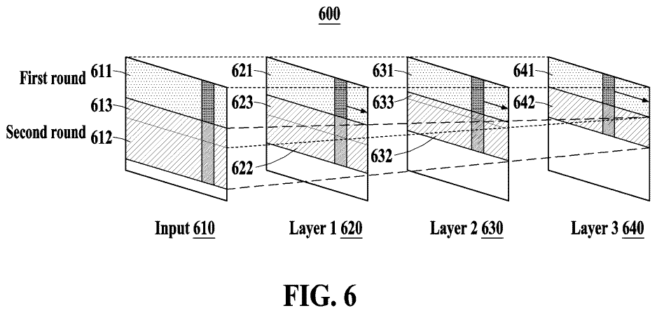

FIG. 6 illustrates an example process with second-direction overlap data according to one or more embodiments. The description provided with reference to FIGS. 1 to 5 may substantially equally apply to FIG. 6.

Referring to FIG. 6, in a non-limiting example, a process 600 is expressed as a first round and a second round for ease of description, but the terms “first round” and “second round” are used to distinguish consecutive processes within process 600 and do not actually indicate that the rounds progress in a vertical direction. The rounds may progress horizontally, and after operations for the tiles above are completed, the process 600 may move on to operations for the tiles below.

First, in an example, the operations of the first round (for the tiles above) may start based on a first area 611 of the input data 610. The data may be used as an input of the first layer 620, and output data 621 of the first layer may be generated as an operation result. In this process, horizontal overlap data 613 of the output data 621 may be stored in a global memory or an external memory (e.g., DRAM). Thereafter, the operation of the first round may proceed to a first area 631 of the second layer 630, and an operation may be performed using the output data 621 of the first layer as an input. Output data 632 of the second layer 630 may be generated as an operation result, and a horizontal edge portion 633 of the data may be stored again in the global memory or the external memory (e.g., DRAM). Similarly, an operation on a first area 641 of the third layer 640 may be performed to generate final output data.

In an example, after the operations on all layers of the first round are completed, the operations of the second round (for the tiles below) may begin. In the second round, operations may be performed based on a second area 612 of the input data 610, and together with this, the horizontal overlap data 613 of the first round stored in the global memory may be loaded and combined with the input data 610. Second output data 622 of the first layer 620 may be generated based on the data, and in this process, horizontal overlap data 623 already stored in the global memory or the external memory (e.g., DRAM) may be used as is. Operations of the second layer 630 and the third layer 640 may be performed in a similar manner, and each output data 632 and 642 may be used as an operation input by loading overlap data 633 and 643 stored in the global memory or an external memory (e.g., DRAM).

Examples of the apparatus (e.g., electronic apparatus 500) employing process 600 may efficiently utilize memory resources by storing horizontal overlap data in the global memory or the external memory (e.g., DRAM) rather than a local memory, considering a characteristic of the structure in which the horizontal overlap data is not used in consecutive rounds. In addition, by controlling an amount of the horizontal overlap data, a vertical size of an input tile (i.e., an input tile height) may be prevented from becoming excessively large. Accordingly, flexibility to horizontally extend tile sizes may be provided and operational efficiency may be maximized. Although some overhead may occur due to an increase in DRAM accesses, the present disclosure may provide higher performance and resource utilization compared to the typical methods and apparatuses by maintaining a balance between operational efficiency and memory utilization through appropriate control on the overhead.

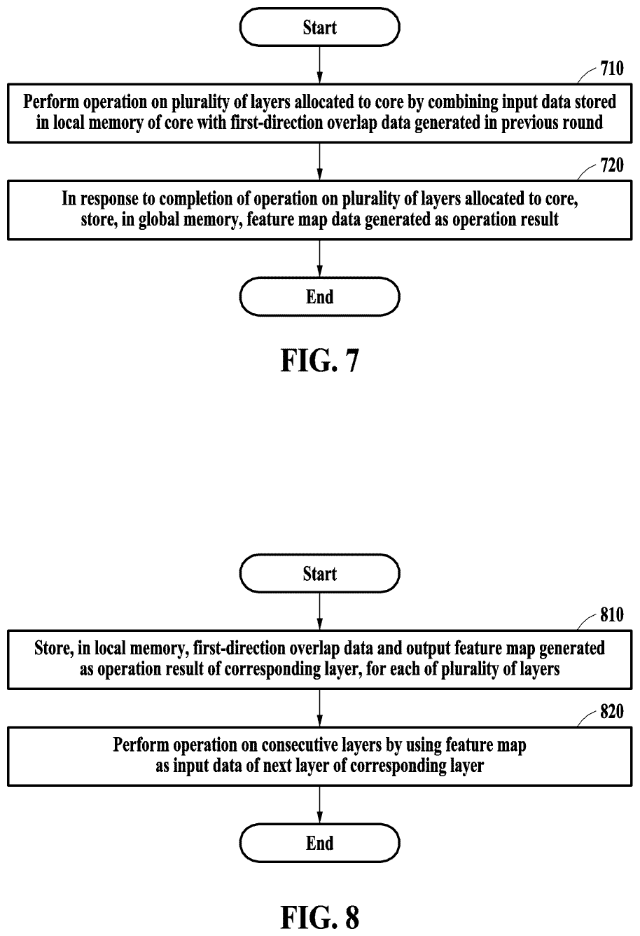

FIG. 7 illustrates an example method according to one or more embodiments. The description provided with reference to FIGS. 1 to 6 may also apply to FIG. 7.

Referring to FIG. 7, in a non-limiting example, in operation 710, an operation is performed on a plurality of layers allocated to a core by combining input data stored in a local memory of the core with first-direction overlap data generated in a previous round stored in the local memory or a global memory. The local memory may store the input data, hold the overlap data generated in the previous round, and combine the input data with the overlap data to form data required for each layer. For example, the input data may be loaded from the global memory, and the first-direction overlap data generated in the previous round may already be stored in the local memory. The data may be combined and sequential operations may be performed on each layer. In this process, an operation result of each layer may be used as input data for a next layer, and operations on the plurality of layers may be performed sequentially.

In an example, in operation 720, when operations on the plurality of layers allocated to the core are completed, feature map data generated as an operation result may be stored in the global memory. Feature map data operated in a specific core may be used as input data of skip connection operations or layers performed on other cores. Thus, the global memory may allow data to be shared between each core and ensure continuity between operations. That is, the feature map data stored in the global memory may be configured in a format that allows retrieval and use by other cores to be provided as operation input data to one or more of those other cores.

The method illustrated in FIG. 7 shows that operational efficiency may be maximized by effectively utilizing the local memory and the global memory while each core operates independently in a multi-core structure. In particular, the structure in which the first-direction overlap data is combined with the input data to perform consecutive operations on the plurality of layers may contribute to reducing an amount of memory accesses and increasing operational performance compared to typical methods. In addition, by storing operation results in the global memory, flexibility and data dependency of the entire system may be effectively managed. This method may clearly demonstrate that the present disclosure may overcome limitations that may occur in typical multi-core structures and may optimize operational performance and resource utilization.

FIG. 8 illustrates an example method according to one or more embodiments. The description provided with reference to FIGS. 1 to 7 may also apply to FIG. 8.

Referring to FIG. 8, in a non-limiting example, in operation 810, for each of a plurality of layers, first-direction overlap data and an output feature map generated as an operation result of a corresponding layer may be stored in a local memory. Each layer may perform operations based on input data and overlap data generated in a previous round, and in this process, the output feature map and edge data of the corresponding layer may be generated. The output feature map may be used as input data for the next layer, and the first-direction overlap data may be stored in the local memory to ensure data connectivity in subsequent operations. This data storage process may play an important role in improving operational efficiency and maintaining a continuous data flow.

In an example, in operation 820, the stored output feature map may be used as input data for the next layer of the corresponding layer to perform operations on consecutive layers. The output feature map generated in each layer may be transferred to the next layer through the local memory, and operations may proceed based on this.

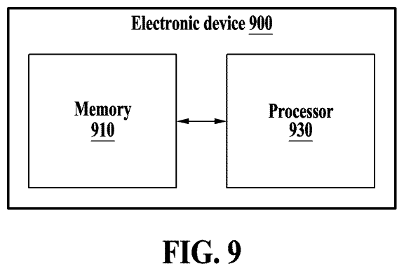

FIG. 9 illustrates an example electronic device according to one or more embodiments. The description provided with reference to FIGS. 1 to 8 may substantially equally apply to FIG. 9.

Referring to FIG. 9, in a non-limiting example, an electronic device 900 may include a memory 910 and a processor 930. The electronic device 900 may include various computing devices such as a mobile phone, a smart phone, a tablet, a camera device, an e-book device, a laptop, a personal computer, a desktop, a workstation, or a server, various wearable devices such as a smart watch, smart glasses, a head-mounted display (HMD), or smart clothing, various home appliances such as a smart TV or a smart refrigerator, a smart car, a smart kiosk, an Internet of things (IoT) device, a walking assist device (WAD), a drone, or a robot.

The memory 910 may include computer-readable instructions. The processor 930 may be configured to execute computer-readable instructions, such as those stored in the memory 910, and through execution of the computer-readable instructions, the processor 930 is configured to perform one or more, or any combination, of the operations and/or methods described herein. The memory 910 may be a volatile or nonvolatile memory.

The volatile memory device may be implemented as DRAM, static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 930 may be configured to execute programs or applications to configure the processor 930 to control the electronic apparatus 900 to perform one or more or all operations and/or methods involving data processing, and may include any one or a combination of two or more of, for example, a central processing unit (CPU), a graphic processing unit (GPU), a neural processing unit (NPU) and tensor processing units (TPUs), but is not limited to the above-described examples.

In an example, the processor may load input data from the global memory to the local memory and stores it, performs operations on multiple layers by combining the input data stored in the local memory with the first direction overlap data generated in the previous round, and when the operations on the multiple layers are completed, stores feature map data generated as a result of the operations in the global memory. The processor 930 may perform the operations described with reference to FIGS. 1 to 8 in substantially the same manner. Accordingly, a detailed description thereof is omitted.

The electronic apparatuses, electronic devices, processors, memories, neural networks, electronic apparatus 200, global memory 210, plurality of cores 220-1, 220-2, . . . 220-n, electronic apparatus 400, global memory 411, WMEM arbiter 420, WMEM 421, vector unit 442, vector unit 444, FMAP buffer 441, GEMM unit 443, IMEM 449, core 430, core 440, FMAP buffer 441, electronic apparatus 500, global memory 511, WMEM arbiter 520, MEM 521, core 530, core 540, DMA 560, first subcore 550-1, second subcore 550-2, electronic device 900, memory 910, and process 930 described herein and disclosed herein described with respect to FIG. 1-_ are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
combining, in a current round of a current operation for a plurality of layers allocated to a core input data stored in a local memory of the core with first-direction overlap data generated in a previous round;
in response to completion of the current operation on the plurality of layers allocated to the core, storing, in a global memory, feature map data generated as an operation result,
storing, in the local memory or the global memory, first-direction overlap data and an output feature map generated as an operation result of a corresponding layer, for each of the plurality of layers; and
performing additional operations on consecutive layers by using the output feature map as input data of a next layer of the corresponding layer.

2. The method of claim 1, further comprising:
loading input data from the global memory to the local memory of the core,
wherein the input data stored in the local memory of the core comprises:
one or more of the input data loaded from the global memory or output data of a previous layer of the corresponding layer, stored in the local memory.

3. The method of claim 1, wherein the first-direction overlap data is generated in the previous round as an operation result of a layer allocated to the core, and
wherein the first-direction overlap data is reused in the current round as operation input data of a same layer allocated to the core.

4. The method of claim 1, wherein the first-direction overlap data is set in a direction orthogonal to a direction of progress of rounds.

5. The method of claim 1, wherein the feature map data stored in the global memory is configured to be provided as operation input data of a layer performed in another core.

6. The method of claim 1, wherein the feature map data stored in the global memory is configured for a skip connection operation among operations of another layer.

7. The method of claim 1, wherein a plurality of cores is configured to share the feature map data stored in the global memory, and
wherein each core of the plurality of cores is configured to independently perform an allocated layer operation of an allocated layer based on the feature map data.

8. The method of claim 1, comprising:
storing, in the global memory or an external memory, second-direction overlap data generated in a current round; and
using the second-direction overlap data stored in the global memory or the external memory as operation input data of the core in one or more subsequent rounds according to a condition.

9. The method of claim 1, wherein the core comprises a plurality of subcores, and
wherein the plurality of subcores are configured to operate independently or collaboratively to process core data allocated to the subcores.

10. The method of claim 1, wherein the performing of the additional operations on the consecutive layers comprises:
performing fusion processing of the consecutive layers.

11. An electronic apparatus comprising a plurality of cores, the apparatus comprising:
a global memory;
a local memory included in each of the plurality of cores;
a processor included in each of the plurality of cores, the processor being configured to execute instructions; and
a memory included in each of the plurality of cores, the memory storing the instructions, wherein execution of the instructions respectively configures the processor to:
load input data from the global memory to the local memory to store the input data in the local memory;
combine for a current round of a current operation, for a plurality of layers, the input data stored in the local memory with first-direction overlap data generated in a previous round, the first-direction overlap data being stored in one of the local memory or the global memory; and
in response to completion of the current operation on the plurality of layers, storing, in the global memory, feature map data generated as an operation result.

12. The apparatus of claim 11, wherein the input data stored in the local memory comprises:
one or more of the input data loaded from the global memory or output data of a previous layer, among the plurality of layers, stored in the local memory.

13. The apparatus of claim 11, wherein the processor is further configured to:
store, in the local memory, first-direction overlap data and an output feature map generated as an operation result of a corresponding layer, for each of the plurality of layers; and
perform additional operations on consecutive layers by using the output feature map as input data of a next layer.

14. The apparatus of claim 11, wherein the first-direction overlap data is generated in the previous round by the processor, and
wherein the first-direction overlap data is reused in a current round as operation input data of a same layer among the plurality of layers.

15. The apparatus of claim 11, wherein the first-direction overlap data is set in a direction orthogonal to a direction of progress of rounds.

16. The apparatus of claim 11, wherein the feature map data stored in the global memory is configured to be provided as input data of an operation performed in another core among the plurality of cores.

17. The apparatus of claim 11, wherein the feature map data stored in the global memory is configured to perform skip connection among other operations.

18. The apparatus of claim 11, wherein the plurality of cores is configured to share the feature map data stored in the global memory, and
wherein each core of the plurality of cores is configured to independently perform an allocated operation based on the feature map data.

19. The apparatus of claim 11, wherein the processor is further configured to:
store, in the global memory or an external memory, second-direction overlap data generated in a current round; and
use the second-direction overlap data stored in the global memory or the external memory as input data of the processor in a subsequent round according to a condition.

20. The apparatus of claim 11, wherein the processor comprises a plurality of subcores, and
wherein the plurality of subcores are configured to operate independently or collaboratively to process core data allocated to the subcores.
